(19) United States
(12) Patent Application Publication
(10) Pub. No.: US 2007/0248821 A1
(43) Pub. Date: Oct. 25, 2007

(54) Enameling Varnish Composition, in Particular for Magnet Wire

(76) Inventors: Jerome Fournier, Lyon (FR); Arnaud Piechaczyk, Lyon (FR); Laurent Schildknecht, Lyon (FR); Olivier Pinto, Lyon (FR)

Correspondence Address: SOFER & HAROUN LLP., 317 MADISON AVENUE, SUITE 910, NEW YORK, NY, 10017, US

(21) Appl. No.: 11/660,189

(22) PCT Filed: Aug. 30, 2005
(86) PCT No.: PCT/FR05/50691

§ 371 Date: Jul. 2, 2007

(30) Foreign Application Priority Data
Aug. 30, 2004 (FR) 0451933

(51) Int. Cl. C09D 5/25; C09D 7/00; H01B 3/30; H01F 27/32

(52) U.S. Cl. 428/375; 106/3

(57) ABSTRACT

The present invention relates to an enameling varnish composition, in particular for magnet wire. The invention is remarkable in that the enameling varnish composition comprises a polymer resin and an alkyl lactate, and in that the polymer resin is selected from the group comprising polyesters, polyester imides, THEIC-modified polyester imides, polyurethanes, polyamides, polyamide imides, polyvinyl acetoformals, and any mixture of these compounds.

The present invention relates to a composition for constituting an electrically insulating enameling varnish.

The invention finds a particularly advantageous but non-exclusive application in the field of magnet wires.

The great majority of varnishes used for insulating enameled wires are produced in the form of a solution of polymer in a mixture of cresylic and aromatic hydrocarbon solvents, or in a mixture of N-methyl pyrollidone and aromatic hydrocarbons. The effectiveness of those solvents is quite manifest in practice, whether during synthesis of the varnish, in terms of solubility, or at the time of application onto the conductor wire.

Nevertheless, cresylic solvents are also known for being highly toxic substances, and they also have odors that are very disagreeable. N-methyl pyrollidone, commonly designated by the abbreviation NMP, is suspected of being toxic. Nowadays, the entire enameled wire industry is subjected to ever-increasing pressure to reduce the use of those conventional solvents.

Enameling varnishes having no cresylic solvents have naturally been developed.

In this respect, benzyl alcohol is known as a good solvent for taking the place of cresol and phenol in particular, however its toxicity remains too great and its cost price is disadvantageously greater.

It is also possible to use propyl methoxy acetate, better known under the trademark Dowanol PMA. Unfortunately, that product is expensive and presents low calorific efficiency during enameling. The surface appearance of the varnish is also not sufficiently good in most circumstances.

Although, a priori, water can also be used to replace cresylic solvents, it is completely ill-adapted to standard enameling machines. Such machines require a solvent that can supply energy by combustion, i.e. an organic solvent. Independently of the extra cost that a new fabrication method would imply, the performance of the final product always turns out to be less good than that of varnishes based on cresylic solvents.

Thus, the technical problem to be solved by the subject matter of the present invention is to propose an enameling varnish composition, in particular for magnet wire, which composition makes it possible to avoid the problems of the state of the art by providing a toxic solvent content that is significantly reduced, while preserving the performance of the final product and not undermining the standard enameling methods presently in use.

According to the present invention, the solution to the technical problem posed consists in that the enameling varnish composition comprises a polymer resin and an alkyl lactate, and in that the polymer resin is selected from the group comprising polyesters, polyester imides, THEIC-modified polyester imides, polyurethanes, polyamides, polyamide imides, polyvinyl acetoformals, and any mixture of these compounds.

The invention as defined in this way thus consists in substituting at least a fraction of the toxic solvents commonly used in the prior art, and in particular cresylic solvents, by a solvent that is itself known and recognized as not being noxious in any way, specifically lactate. This makes it possible to reduce the toxicity of the enameling varnish to a greater or lesser extent.

Solvents of the lactate type present the advantage of not spoiling the mechanical and insulating properties of the enameling varnishes in which they are integrated. As example applications, enameled wires prepared from varnishes based on lactates provide the same performance as corresponding wires made using varnishes of conventional formulations.

Lactate type solvents also give excellent stability to the enameling varnish, good capacity for application, and a surface state that is entirely satisfactory.

The prices of lactates, and in particular of ethyl lactate, are also found to be of the same order of magnitude as the prices of cresol and of NMP, such that using them advantageously leads to no particular increase in cost.

According to a feature of the invention, the alkyl lactate is selected from methyl lactate, ethyl lactate, propyl lactate, butyl lactate, and any mixture of these compounds.

A first embodiment of the invention is associated with the fact that the polymer resin is selected from the group comprising polyesters, polyester imides, THEIC-modified polyester imides, polyurethanes, polyvinyl acetoformals, or any mixture of these compositions. Under such conditions, the proportion by weight of alkyl lactate relative to the total quantity of solvents may advantageously lie in the range 5% to 100%, and preferably in the range 10% to 70%. In other words, this means that when the polymer resin is as defined above, the composition of the enameling varnish may comprise 5% to 100% by weight of alkyl lactate, preferably 10% to 70% by weight, relative to the total quantity of solvents.

In particularly advantageous manner, a composition in accordance with this first embodiment may further include at least one cresylic solvent. In this respect, it should be observed that the term “cresylic solvent” designates equally well phenol, cresol, xylenol, and derivatives thereof.

The essential purpose of this characteristic is to obtain a final varnish in which the mechanical and insulating properties are equivalent to those of varnishes based on cresylic solvents, specifically in order to avoid undermining the standard fabrication methods presently in use.

A second embodiment of the invention relates to varnishing compositions in which the polymer resin is selected from polyamides, polyamide imides, or any mixture of these compositions. Under these circumstances, the proportion by weight of alkyl lactate may advantageously be in the range 5% to 70% relative to the total quantity of solvents, and preferably in the range 10% to 40%.

In accordance with an advantageous characteristic of this second embodiment, the enameling varnish composition may also include N-methyl pyrollidone.

Regardless of whether the enameling varnish satisfies the conditions of the first or the second embodiment of the invention, it may also include at least one aromatic hydrocarbon. In this respect, it should be specified that the term “aromatic hydrocarbon” designates very generally all isomers of xylenes, and also petroleum cuts, and more particularly hydrocarbon cuts having a boiling point lying in the range 160° C. to 210° C.

The presence of aromatics in the enameling varnish composition enables the cost price thereof to be reduced, possibly serves to adjust viscosity, and also serves to raise the boiling point of the solvent mixture. With more particular concern for the boiling point, the purpose is to avoid being penalized by the relatively low boiling point of lactates, which is generally to be found in the range 145° C. to 170° C., and thus avoid any risk of drying in the applicators. Such a phenomenon would run the risk of compromising the entire fabrication process.

In any event, the proportion by weight of aromatic hydrocarbon should advantageously lie in the range 10% to 50% relative to the total quantity of solvents.

Naturally, an enameling varnish composition in accordance with the invention may further include any kind of additive known in the state of the art.

Naturally, the invention also relates to any magnet wire comprising a conductor element covered in an insulating layer made from an enameling varnish composition as described above.

Other characteristics and advantages of the present invention appear from the following description of examples; the examples are given by way of non-limiting illustration.

Examples I to V relate to enameling compositions all intended for constituting electrically insulating layers on magnet wires. More precisely, each example relates to compositions constituted by the same polymer resin but with different solvent mixtures, i.e. on each occasion a composition in accordance with the invention and a reference composition having a solvent mixture that is typical of the prior art.

### EXAMPLE I

Samples 1 and 2 both relate to composition based on polyester imide (PEI). They relate respectively to a composition in accordance with the invention, i.e. in which the solvent mixture was provided with lactate, and a reference composition, i.e. in which the solvent mixture was based solely on conventional solvents.

Preparation of Sample 1 began by adding 437 grams (g) of trimellitic anhydride to 285 g of methane diphenyl diisocyanate in 590 g of cresol. The mixture was then heated to 200° C., causing 105 g of carbon dioxide to be given off. Thereafter, 430 g of ethylene glycol, 328 g of trimellitic anhydride, and 51 g of isophthalic acid were introduced into the reactor at 120° C. Heating was carried out under strong stirring up to about 215° C. 110 g of distillate were then recovered. 385 g of ethyl lactate, 20 g of titanate, and then 680 g of aromatic solvent in the form of Solvesso 100 (trademark of the supplier Exxon) were added to obtain an enameling varnish having 44% dry extract and viscosity of 1205 millipascal seconds (mPa·s) at 20° C.

Sample 2 was prepared by adding 437 g of trimellitic anhydride to 285 g of methane diphenyl diisocyanate in 590 g of cresol. The mixture was heated to 200° C., causing 105 g of carbon dioxide to be given off. Thereafter, 430 g of ethylene glycol, 328 g of trimellitic anhydride, and 51 g of isophthalic acid were introduced into the reactor at 120° C. Heating was carried out under strong stirring up to about 215° C. 110 g of distillate were then recovered. 150 g of cresol, 235 g of phenol, 20 g of titanate, and then 680 g of aromatic solvent in the form of Solvesso 100 were added to obtain an enameling varnish having a dry extract of 44% and viscosity of 2600 mPa·s at 20° C.

It should be observed that the titanate introduced was generally tetra n-butyl titanate. That compound acts as a catalyst by the esterification and the trans-esterification reaction. It is also a cross-linking agent.

For greater clarity, Table 1 summarizes the differences of the compositions between the solvent mixtures for Samples 1 and 2.

TABLE 1

| Solvent mixture | Sample 1 | Sample 2 |
|---|---|---|
| Cresol | 35.7% | 45% |
| Ethyl lactate | 23.3% | 0 |
| Phenol | 0 | 14% |
| Solvesso 100 | 41% | 41% |

Viscosity at 20° C., and dry extract concentration after drying 1 g of substance for 1 hour (h) at 180° C. were measured on each of the samples in order to be able to compare the characteristic properties of the previously-prepared enameling varnishes. Table 2 summarizes the results of the measurements in question.

TABLE 2

| | Sample 1 | Sample 2 |
|---|---|---|
| Dry extract (1 h, 1 g, 180° C.) | 44% | 44% |
| Viscosity 20° C. | 1205 mPa · s | 2600 mPa · s |

It can be seen that the characteristic properties of both types of enameling varnish are directly comparable. Nevertheless, it should be observed that the presence of lactate advantageously causes viscosity to drop in a composition in accordance with the invention (Sample 1). This characteristic makes it possible to work with compositions that are much more concentrated.

Magnet wires were then made using the compositions corresponding to Samples 1 and 2 as enameling varnish. Specifically, a determined number of layers of varnish were applied by successive passes at given speed on conductor wires having identical diameters. The extra thickness of varnish, and its surface appearance were then evaluated for each enameled wire.

Standard characterization tests were then carried out to determine the essential properties of both types of magnet wire (in compliance with international standard IEC 60317). Those tests are conventionally tests concerning flexibility, thermal shock at 200° C., and solderability at 475° C. Using a Dansk trademark appliance of type TD300, tangent delta, a value that is well known in the field of enameling, was also determined.

Table 3 combines the structural characteristics of both types of enameled wire, together with their own characteristic properties.

TABLE 3

| | Sample 1 | | Sample 2 | |
|---|---|---|---|---|
| Conductor wire diameter | 0.56 | mm | 0.56 | mm |
| Enameled wire construction | 12 | passes | 12 | passes |
| Surface appearance | smooth | | smooth | |
| Extra thickness | 47 | μm | 48 | μm |
| Enameling speed | 100 | m/min | 100 | m/min |
| Flexibility | 20% | 1D | 20% | 1D |
| Thermal shock (200° C.) | 10% | 1D | 10% | 1D |
| Solderability at 475° C. | 3 | s | 3 | s |
| Tangent delta (Dansk ® TD300) | 175° | C. | 176° | C. |

It can be seen that the enameling results are entirely equivalent. This means that compared with a state of the art solvent mixture, a solvent mixture based on lactate does not in any way harm the performance of enameling varnishes based on polyester imide.

### EXAMPLE II

Samples 3 and 4 both relate to compositions based on polyester imide modified by THEIC. They relate respectively to a composition in accordance with the invention, i.e. in which the solvent mixture was provided with lactate, and to a reference composition, i.e. in which the solvent mixture was based solely on conventional solvent.

Preparation of Sample 3 began with introducing 190 g of ethylene glycol and 435 g of trishydroxyethyl isocyanurate (THEIC) in a reactor at ambient temperature. The mixture was then heated to 120° C. At that temperature, 122 g of methane diphenyl diamine (MDA), 270 g of dimethoxy terephthalate, 277 g of trimellitic anhydride, and 13 g of xylene were introduced into the reactor. 2 g of titanate were then added prior to heating the mixture under strong stirring up to 220° C. 140 g of distillate were then recovered. 927 g of ethyl lactate, 82 g of benzyl alcohol, 44 g of ethylene glycol, and 326 g of Solvesso 150 (trademark of the supplier Exxon) were then added to the varnish. At 60° C., 46 g of titanate and 80 g of phenolic resin were added to the varnish. The resulting varnish had a dry extract of 44% and viscosity of 860 mPa·s at 20° C.

Sample 4 was prepared by introducing 190 g of ethylene glycol and 435 g of THEIC in a reactor at ambient temperature. The mixture was then heated to 120° C. At that temperature, 122 g of methane diphenyl diamine (MDA), 270 g of dimethoxy terephthalate, 277 g of trimellitic anhydride, and 13 g of xylene were introduced into the reactor. 2 g of titanate were then added prior to heating the mixture under strong stirring up to 220° C. 140 g of distillate were then recovered. 463 g of cresol, 463 g of phenol, 82 g of benzyl alcohol, 44 g of ethylene glycol, and 326 g of Solvesso 150 (trademark of the supplier Exxon) were then added to the varnish. At 60° C., 46 g of titanate and 80 g of phenolic resin were added to the varnish. The resulting varnish had a dry extract of 44% and viscosity of 1300 mPa·s at 20° C.

It should be observed that phenolic resin serves to improve the applicability of the varnish, and above all to increase its chemical and thermal resistance.

For reasons of clarity, Table 4 summarizes the differences between the compositions of the solvent mixtures of Samples 3 and 4.

TABLE 4

| Solvent mixture | Sample 3 | Sample 4 |
|---|---|---|
| Ethyl lactate | 67% | 0 |
| Cresol | 0 | 33.5% |
| Phenol | 0 | 33.5% |
| Benzyl alcohol | 6% | 6% |
| Ethylene glycol | 3% | 3% |
| Solvesso 150 | 24% | 24% |

Viscosity at 20° C., and dry extract concentration after drying 1 g of substance for 1 h at 180° C. were measured on each of the samples in order to be able to compare the characteristic properties of the previously-prepared enameling varnishes. Table 5 summarizes the results of the measurements in question.

TABLE 5

| | Sample 3 | Sample 4 |
|---|---|---|
| Dry extract (1 h, 1 g, 180° C.) | 44% | 44% |
| Viscosity 20° C. | 860 mPa · s | 1300 mPa · s |

It can also be seen in this example that the characteristic properties of both types of enameling varnish are directly comparable. It should also be observed that the presence of the lactate causes viscosity to drop in the composition in accordance with the invention (Sample 3), thus advantageously making it possible to work with compositions that are much more concentrated.

Magnet wires were then made using the compositions corresponding to Samples 3 and 4 as enameling varnish. Specifically, a determined number of layers of varnish were applied by successive passes at given speed on conductor wires having identical diameters. The extra thickness of varnish, and its surface appearance were then evaluated for each enameled wire.

Standard characterization tests were then carried out to determine the essential properties of both types of magnet wire. They conventionally comprise flexibility and thermal shock tests at 200° C. As in Example I, tangent delta was determined by using a TD300 type appliance having the trademark Dansk.

Table 6 combines the structural characteristics of both types of enameled wire, together with their own characteristic properties.

TABLE 6

| | Sample 3 | | Sample 4 | |
|---|---|---|---|---|
| Conductor wire diameter | 0.56 | mm | 0.56 | mm |
| Enameled wire construction | 12 | passes | 12 | passes |
| Surface appearance | smooth | | smooth | |
| Extra thickness | 47 | μm | 48 | μm |
| Enameling speed | 100 | m/min | 100 | m/min |
| Flexibility | 20% | 1D | 20% | 1D |
| Thermal shock (200° C.) | 10% | 1D | 10% | 1D |
| Tangent delta (Dansk ® TD300) | 186° | C. | 184° | C. |

It can be seen that the enameling results are entirely equivalent. This means that compared with a state of the art solvent mixture, a solvent mixture based on lactate does nothing to spoil the performance of an enameling varnish based on THEIC-modified polyester imide.

### EXAMPLE III

Samples 5 and 6 both relate to compositions based on polyurethane. They relate respectively to a composition in accordance with the invention, i.e. in which the solvent mixture was provided with lactate, and to a reference composition, i.e. in which the solvent mixture was based solely on conventional solvents.

The preparation of Sample 5 began by introducing 416.5 g of cresol, 544 g of ethyl lactate, and 55.4 g of xylene in the reactor. 120 g of trimethylolpropane (TMP) and 26 g of THEIC were added at 60° C. The mixture was heated until the xylene had been totally distilled. After cooling, 835 g of methane diphenyl diisocyanate and 1.5 g of catalyst were introduced. The varnish was then heated under strong stirring up to 140° C. At this temperature, 412 g of aromatic solvent (Solvesso 100—Exxon), 388.7 g of xylene, and 256 g of ethyl lactate were added so as to obtain a blocked polyisocyanate isocyanate in solution.

Thereafter, 3000 g of blocked polyisocyanate isocyanate in solution and 5858 g of polyester imide containing ethyl lactate (Sample 1) were introduced into a reactor. At 50° C., 7 g of catalyst were added to the mixture. To achieve a dry extract of 40%, 100 g of cresol then 68 g of aromatic solvent (Solvesso 100—Exxon) were added to the varnish.

Sample 6 was prepared by introducing 960.5 g of cresol and 55.4 g of xylene in the reactor. 120 g of trimethylolpropane (TMP) and 26 g of THEIC were added at 60° C. The mixture was heated until the xylene had been totally distilled. After cooling, 835 g of methane diphenyl diisocyanate and 1.5 g of catalyst were introduced. The varnish was then heated under strong stirring up to 140° C. At this temperature, 412 g of aromatic solvent (Solvesso 100—Exxon), 388.7 g of xylene, and 256 g of phenol were added so as to obtain a blocked polyisocyanate isocyanate in solution.

Thereafter, 3000 g of blocked polyisocyanate isocyanate in solution and 5858 g of polyester imide (Sample 2) were introduced into a reactor. At 50° C., 7 g of catalyst were added to the mixture. To achieve a dry extract of 40%, 100 g of cresol then 68 g of aromatic solvent (Solvesso 100—Exxon) were added to the varnish.

For greater clarity, Table 7 summarizes the differences of the compositions between the solvent mixtures of Samples 5 and 6.

TABLE 7

| Solvent mixture | Sample 5 | Sample 6 |
|---|---|---|
| Ethyl lactate | 30.9% | 0 |
| Cresol | 25.4% | 42.4% |
| Phenol | 0 | 14.1% |
| Solvesso 100 | 36% | 36% |
| Xylene | 7.7% | 7.7% |

Viscosity at 20° C., and dry extract concentration after drying 1 g of substance for 1 h at 180° C. were measured on each of the samples in order to be able to compare the characteristic properties of the previously-prepared enameling varnishes. Table 8 summarizes the results of the measurements in question.

TABLE 8

| | Sample 3 | Sample 4 |
|---|---|---|
| Dry extract (1 h, 1 g, 180° C.) | 44% | 44% |
| Viscosity 20° C. | 1050 mPa · s | 1820 mPa · s |

It can be seen again in this example that the characteristic properties of both types of enameling varnish are directly comparable. It can also be seen that the presence of lactate advantageously lowers the viscosity in the composition in accordance with the invention (Sample 5), thus making it possible to work with compositions that are much more concentrated.

Magnet wires were then made using the compositions corresponding to Samples 5 and 6 as enameling varnish. Specifically, a determined number of layers of varnish were applied by successive passes at given speed on conductor wires having identical diameters. The extra thickness of varnish, and its surface appearance were then evaluated for each enameled wire.

Standard characterization tests were then carried out to determine the essential properties of both types of magnet wire. The tests were conventional flexibility and thermal shock tests at 200° C., and solderability at 390° C. Using a Dansk trademark appliance of type TD300, the value of tangent delta was also measured.

Table 9 combines the structural characteristics of both types of enameled wire, together with their own characteristic properties.

TABLE 9

| | Sample 5 | | Sample 6 | |
|---|---|---|---|---|
| Conductor wire diameter | 0.56 | mm | 0.56 | mm |
| Enameled wire construction | 12 passes + | | 12 passes + | |
| | 2 nylon passes | | 2 nylon passes | |
| Surface appearance | smooth | | smooth | |
| Extra thickness | 46 | μm | 46 | μm |
| Enameling speed | 134 | m/min | 134 | m/min |
| Flexibility | 20% | 1D | 20% | 1D |
| Thermal shock (200° C.) | 10% | 1D | 10% | 1D |
| Solderability at 390° C. | 1.5 | s | 2 | s |
| Tangent delta (Dansk ® TD300) | 166° | C. | 164° | C. |

In a manner analogous to the preceding examples, it can be seen that the enameling results are entirely equivalent. This means that compared with a state of the art solvent mixture, a solvent mixture based on lactate does not spoil in any way the performance of an enameling varnish based on polyurethane.

### EXAMPLE IV

Samples 7 and 8 both relate to compositions based on polyvinyl acetoformal (PVF). They relate respectively to a composition in accordance with the invention, i.e. in which the solvent mixture was provided with lactate, and to a reference composition, i.e. in which the solvent mixture was based solely on conventional solvents.

The preparation of Sample 7 began by loading the following cold: 755 g of ethyl lactate, 799 g of aromatic solvent (Solvesso 100), and 278.5 g of xylene. Then 429 g of polyvinyl acetoformal powder were added at 90° C. The mixture was maintained at 90° C. for 1 h and then cooled. 61.2 g of Desmodur AP blocked polyisocyanate (trademark of the supplier Bayer) were introduced at 80° C. and the varnish was maintained at that temperature for 1 h and until it became perfectly limpid. The mixture was then cooled to 50° C. by adding 255 g of xylene. After stirring strongly, 306 g of phenolic resin and 37 g of melamine resin were added to the varnish. The varnish was finally diluted with 2.5 g of aromatic solvent (Solvesso 100) and 69 g of ethyl lactate in order to achieve a dry extract of 19.5% and viscosity of 5200 mPa·s.

Sample 8 was prepared by loading the following while cold: 528.5 g of cresol, 226.5 g of phenol, 799 g of aromatic solvent (Solvesso 100—Exxon), and 278.5 g of xylene. Then 429 g of polyvinyl acetoformal powder were added at 90° C. The mixture was maintained at 90° C. for 1 h and then cooled. 61.2 g of Desmodur AP blocked polyisocyanate were introduced at 80° C. and the varnish was maintained at that temperature for 1 h and until it became perfectly limpid. The mixture was then cooled to 50° C. by adding 255 g of xylene. After stirring strongly, 306 g of phenolic resin and 37 g of melamine resin were added to the varnish. The varnish was finally diluted with 2.5 g of aromatic solvent (Solvesso 100) and 69 g of ethyl lactate in order to achieve a dry extract of 19.7% and viscosity of 6450 mPa·s.

It should be observed that phenolic resin makes it possible in these examples to obtain good resistance to hydrolysis, and that the melamine resin provides improved chemical behavior.

For greater clarity, Table 10 summarizes the composition differences between the solvent mixtures of Samples 7 and 8.

TABLE 10

| Solvent mixture | Sample 7 | Sample 8 |
|---|---|---|
| Ethyl lactate | 34.5% | 0 |
| Cresol | 9% | 31.2% |
| Phenol | 0 | 12.3% |
| Solvesso 100 | 33.6% | 33.6% |
| Xylene | 22.9% | 22.9% |

Viscosity at 20° C., and dry extract concentration after drying 1 g of substance for 1 h at 180° C. were measured on each of the samples in order to be able to compare the characteristic properties of the previously-prepared enameling varnishes. Table 11 summarizes the results of the measurements in question.

TABLE 11

| | Sample 7 | Sample 8 |
|---|---|---|
| Dry extract (1 h, 1 g, 180° C.) | 19.5% | 19.7% |
| Viscosity 20° C. | 5200 mPa · s | 6450 mPa · s |

Here again, it can be seen that the characteristic properties of both types of enameling varnish are directly comparable and that the presence of lactate advantageously causes viscosity to drop in a composition in accordance with the invention (Sample 7).

Magnet wires were then made using the compositions corresponding to Samples 7 and 8 as enameling varnish. Specifically, a determined number of layers of varnish were applied by successive passes at given speed on conductor wires having identical diameters. The extra thickness of varnish, and its surface appearance were then evaluated for each enameled wire.

Standard characterization tests were then carried out to determine the essential properties of both types of magnet wire. These conventionally comprise a flexibility test, a thermal shock test at 160° C. for 30 minutes, unidirectional abrasion, and breakdown voltage.

Table 12 combines the structural characteristics of both types of enameled wire, together with their own characteristic properties.

TABLE 12

| | Sample 7 | | Sample 8 | |
|---|---|---|---|---|
| Conductor wire diameter | 1.55 | mm | 1.55 | mm |
| Enameled wire construction | 6 | passes | 6 | passes |
| Surface appearance | smooth | | smooth | |
| Extra thickness | 70 | μm | 70 | μm |
| Enameling speed | 7 | m/min | 7 | m/min |
| Flexibility | 20% | 1D | 20% | 1D |
| Thermal shock (160° C., 30 min) | 10% | 1D | 10% | 1D |
| Unidirectional abrasion | 1250 | g | 1320 | g |
| Breakdown voltage | 6040 | V | 5900 | V |

It can still be seen that the enameling results are entirely equivalent. In this example, this means that compared with a state of the art solvent mixture, a lactate based solvent mixture does nothing to spoil the performance of an enameling varnish based on polyvinyl acetoformal.

### EXAMPLE V

Samples 9 and 10 both relate to compositions based on polyamide imide (PAI). They relate respectively to a composition in accordance with the invention, i.e. in which the solvent mixture was provided with lactate, and to a reference composition, i.e. in which the solvent mixture was based solely on conventional solvents.

The preparation of Sample 9 began by introducing at 60° C.: 2420 g of N-methyl pyrrolidone, 30.4 g of blocking agent, 836 g of trimellitic anhydride, 81 g of terephthalic acid, 580 g of aromatic solvent (Solvesso 100 from the supplier Exxon), and 1258 g of methane diphenyl diisocyanate. The reaction mixture was heated to 140° C. in 5 h and progress of the reaction was monitored by measuring viscosity and observing CO₂ being given off. Once the desired viscosity was reached, the reactor was cooled by adding 712 g of N-methyl pyrrolidone and 1200 g of ethyl lactate. An enameling varnish having 30% dry extract and viscosity of 2080 mPa·s at 20° C. was then obtained.

Sample 10 was prepared by introducing at 60° C.: 2420 g of N-methyl pyrrolidone, 30.4 g of blocking agent, 836 g of trimellitic anhydride, 81 g of terephthalic acid, 580 g of aromatic solvent (Solvesso 100), and 1258 g of methane diphenyl diisocyanate. The reaction mixture was heated to 140° C. in 5 h and progress of the reaction was monitored by measuring viscosity and observing CO₂ being given off. Once the desired viscosity was reached, the reactor was cooled by adding 1212 g of N-methyl pyrrolidone and 700 g of aromatic solvent (Solvesso 100). An enameling varnish having 30% dry extract and viscosity of 2820 mPa·s at 20° C. was then obtained.

For greater clarity, Table 13 summarizes the composition differences between the solvent mixtures of Samples 9 and 10.

TABLE 13

| Solvent mixture | Sample 9 | Sample 10 |
|---|---|---|
| NMP | 63.8% | 74% |
| Ethyl lactate | 24.4% | 0 |
| Solvesso 100 | 11.8% | 26% |

Viscosity at 20° C., and dry extract concentration after drying 1 g of substance for 1 h at 180° C. were measured on each of the samples in order to be able to compare the characteristic properties of the previously-prepared enameling varnishes. Table 14 summarizes the results of the measurements in question.

TABLE 14

| | Sample 9 | Sample 10 |
|---|---|---|
| Dry extract (1 h, 1 g, 180° C.) | 30.2% | 30.4% |
| Viscosity 20° C. | 2080 mPa · s | 2820 mPa · s |

Once more it can be seen that the characteristic properties of both types of enameling varnish are directly comparable and that the presence of lactate again causes the viscosity to drop in the composition in accordance with the invention (Sample 9).

Magnet wires were then made using the compositions corresponding to Samples 9 and 10 as enameling varnish. Specifically, a determined number of layers of varnish were applied by successive passes at given speed on conductor wires having identical diameters. The extra thickness of varnish, and its surface appearance were then evaluated for each enameled wire.

Standard characterization tests were then carried out to determine the essential properties of both types of magnet wire. They conventionally comprise a flexibility test, and a thermal shock test at 220° C. Tangent delta was also determined with the help of a TD300 type appliance having the trademark Dansk.

Table 15 combines the structural characteristics of both types of enameled wire, together with their own characteristic properties.

TABLE 15

| | Sample 9 | | Sample 10 | |
|---|---|---|---|---|
| Conductor wire diameter | 0.56 | mm | 0.56 | mm |
| Enameled wire construction | 11 passes PEI + | | 11 passes PEI + | |
| | 4 passes PAI | | 4 passes PAI | |
| Surface appearance | smooth | | smooth | |
| Extra thickness | 47 | μm | 48 | μm |
| Enameling speed | 95 | m/min | 95 | m/min |
| Flexibility | 20% | 1D | 20% | 1D |
| Thermal shock (220° C.) | 10% | 1D | 10% | 1D |
| Tangent delta of PAI | 268° | C. | 263° | C. |
| (Dansk ® TD300) | | | | |

Once again it can be seen that the results of enameling are entirely equivalent. This means that compared with a state of the art solvent mixture, a solvent mixture based on lactate does nothing to spoil the performance of an enameling varnish based on polyamide imide.

1. An enameling varnish composition in particular for magnet wire comprising:
a polymer resin; and
an alkyl lactate, wherein the polymer resin is selected from the group consisting of polyesters, polyester imides, THEIC-modified polyester imides, polyurethanes, polyamides, polyamide imides, polyvinyl acetoformals, and any mixture of these compounds.

2. A composition according to claim 1, wherein the alkyl lactate is selected from the group consisting of methyl lactate, ethyl lactate, propyl lactate, butyl lactate, and any mixture of these compounds.

3. A composition according to claim 1, wherein the polymer resin is selected from the group consisting of polyesters, polyester imides, THEIC-modified polyester imides, polyurethanes, polyvinyl acetoformals, and any mixture of these compounds, and said composition comprises 5% to 100% by weight of alkyl lactate relative to the total quantity of solvents.

4. A composition according to claim 3, wherein it further comprises at least one cresylic solvent.

5. A composition according to claim 1, wherein the polymer resin is selected from the group consisting of polyamides, polyamide imides, and any mixture of these compounds, said composition comprising 5% to 70% by weight of alkyl lactate relative to the total quantity of solvents.

6. A composition according to claim 5, wherein it further comprises N-methyl pyrollidone.

7. A composition according to claim 1, wherein it further comprises at least one aromatic hydrocarbon.

8. A composition according to claim 7, wherein it comprises 10% to 50% by weight of aromatic hydrocarbon, relative to the total quantity of solvents.

9. A magnet wire comprising:
a conductor element covered in an insulating layer, wherein the insulating layer is made from an enameling varnish composition according to claim 1.

10. A composition according to claim 3, wherein said composition comprises 10% to 70% by weight of alkyl lactate relative to the total quantity of solvents.

11. A composition according to claim 5, wherein the composition comprises 10% to 40% by weight of alkyl lactate relative to the total quantity of solvents.
